(19) United States
(12) Patent Application Publication
(10) Pub. No.: US 2023/0054391 A1
(43) Pub. Date: Feb. 23, 2023

(54) CALIBRATION OF QUANTUM MEASUREMENT DEVICE

(71) Applicant: BEIJING BAIDU NETCOM SCIENCE TECHNOLOGY CO., LTD., Beijing (CN)

(72) Inventor: Kun WANG, Beijing (CN)

(73) Assignee: BEIJING BAIDU NETCOM SCIENCE TECHNOLOGY CO., LTD., Beijing (CN)

(21) Appl. No.: 17/980,503

(22) Filed: Nov. 3, 2022

(30) Foreign Application Priority Data
Nov. 5, 2021 (KR) 202111304804.7

(51) Int. Cl. G06N 10/20

(52) U.S. Cl. CPC G06N 10/20

(57) ABSTRACT

A method is provided. The method includes: determining an order of a crosstalk noise of a quantum computer; determining a set of calibration circuits based on the order of the crosstalk noise; preparing a respective standard basis quantum state based on each calibration circuit in the set of calibration circuits, the quantum measurement device is repeatedly run for a predetermined number of times for each standard basis quantum state to measure the standard basis quantum state and to obtain a predetermined number of measurement results ; performing a statistic process on the obtained predetermined number of measurement results corresponding to each standard basis quantum state, to obtain a set of calibration data; determining a global generator based on a hardware topological structure of the quantum computer and the set of calibration data; and constructing a calibration matrix based on the global generator, so as to correct the measurement results of the quantum computer based on the calibration matrix.

### CROSS REFERENCE TO RELATED APPLICATIONS

The present application claims priority to Chinese Patent Application No. 202111304804.7 filed on Nov. 5, 2021, the content of which is hereby incorporated by reference in its entirety for all purposes.

### TECHNICAL FIELD

The present disclosure relates to the field of computers, in particular to the technical field of quantum computers, and, more specifically, relates to a quantum measurement device calibration method and apparatus, an electronic device, a computer readable storage medium and a computer program product.

### BACKGROUND

A quantum computer technology has been rapidly developed in recent years, but the problem of noises in quantum computers is unavoidable in the foreseeable future. For example, heat dissipation in qubits or random fluctuations generated in lower-level quantum physical processes, may flip or randomize states of the qubits. Deviations in statistics results read by a measurement device may cause failure of a calculation process.

Specifically, due to limitations of various factors such as instruments, methods, conditions, etc., a quantum measurement device cannot work accurately. As a result, measurement noises are generated, causing deviations in an actual measurement value. Therefore, it is often necessary to reduce the effects of measurement noises so as to obtain an unbiased estimate of a measurement result.

### SUMMARY

The present disclosure provides a quantum measurement device calibration method and apparatus, an electronic device, a computer readable storage medium and a computer program product.

According to one aspect of the present disclosure, a quantum measurement device calibration method is provided and includes: determining an order of a crosstalk noise of a quantum computer; determining a set of calibration circuits based on the order of the crosstalk noise; preparing a respective standard basis quantum state based on each calibration circuit in the set of calibration circuits, wherein for each standard basis quantum state, the quantum measurement device is repeatedly run for a predetermined number of times to measure the standard basis quantum state and to obtain a predetermined number of measurement results; performing a statistic process on the obtained predetermined number of measurement results corresponding to each standard basis quantum state to obtain a set of calibration data; determining a global generator based on a hardware topological structure of the quantum computer and the set of calibration data, wherein the global generator represents the crosstalk noise of the quantum computer determined based on the order of the crosstalk noise; and constructing a calibration matrix based on the global generator, wherein a measurement result obtained by measuring the output result of the quantum computer by the quantum measuring device is corrected based on the calibration matrix.

According to another aspect of the present disclosure, an electronic device is provided and includes: a memory storing one or more programs configured to be executed by one or more processors, the one or more programs including instructions for causing the electronic device to perform operations comprising: determining an order of a crosstalk noise of a quantum computer; determining a set of calibration circuits based on the order of the crosstalk noise; preparing a respective standard basis quantum state based on each calibration circuit in the set of calibration circuits, wherein for each standard basis quantum state, the quantum measurement device is repeatedly run for a predetermined number of times to measure the standard basis quantum state and to obtain a predetermined number of measurement results; performing a statistic process on the obtained predetermined number of measurement results corresponding to each standard basis quantum state to obtain a set of calibration data; determining a global generator based on a hardware topological structure of the quantum computer and the set of calibration data, wherein the global generator represents the crosstalk noise of the quantum computer determined based on the order of the crosstalk noise; and constructing a calibration matrix based on the global generator, wherein a measurement result obtained by measuring the output result of the quantum computer by the quantum measuring device is corrected based on the calibration matrix.

According to another aspect of the present disclosure, a non-transitory computer-readable storage medium that stores one or more programs is provided. The one or more programs comprising instructions that, when executed by one or more processors of an electronic device, cause the electronic device to implement operations comprising: determining an order of a crosstalk noise of a quantum computer; determining a set of calibration circuits based on the order of the crosstalk noise; preparing a respective standard basis quantum state based on each calibration circuit in the set of calibration circuits, wherein for each standard basis quantum state, the quantum measurement device is repeatedly run for a predetermined number of times to measure the standard basis quantum state and to obtain a predetermined number of measurement results; performing a statistic process on the obtained predetermined number of measurement results corresponding to each standard basis quantum state to obtain a set of calibration data; determining a global generator based on a hardware topological structure of the quantum computer and the set of calibration data, wherein the global generator represents the crosstalk noise of the quantum computer determined based on the order of the crosstalk noise; and constructing a calibration matrix based on the global generator, wherein a measurement result obtained by measuring the output result of the quantum computer by the quantum measuring device is corrected based on the calibration matrix..

It should be understood that described contents in this part are neither intended to indicate key or important features of the embodiments of the present disclosure, nor used to limit the scope of the present disclosure. Other features of the present disclosure will become easier to understand through the following specification.

### BRIEF DESCRIPTION OF THE DRAWINGS

Accompanying drawings, constituting a part of the specification, illustrate embodiments and, together with text description of the specification, serve to explain exemplary implementations of the embodiments. The illustrated embodiments only aim to serve as examples rather than limit the scope of the claims. In all the accompanying drawings, same reference numbers represent similar but not necessarily the same elements.

FIG. 1 illustrates a schematic diagram of an exemplary system in which various methods described herein may be implemented according to embodiments of the present disclosure;

FIG. 2 illustrates a flow chart of processing a measurement noise of a quantum measurement device according to an embodiment of the present disclosure;

FIG. 3 illustrates a flow chart of a quantum measurement device calibration method according to an embodiment of the present disclosure;

FIG. 4 illustrates a schematic diagram of a hardware topological structure containing three qubits according to an embodiment of the present disclosure;

FIG. 5 illustrates a graph showing the relationship between the quantity of calibration circuits and a maximum crosstalk noise order according to an embodiment of the present disclosure;

FIG. 6 illustrates a flow chart of determining a global generator according to a hardware topological structure of a quantum computer and a set of calibration data according to an embodiment of the present disclosure;

FIG. 7 illustrates a flow chart of iterating to update a global generator according to an embodiment of the present disclosure;

FIG. 8 illustrates a structural block diagram of a quantum measurement device calibration apparatus according to an embodiment of the present disclosure; and

FIG. 9 illustrates a structural block diagram of an exemplary electronic device that can be used to implement embodiments of the present disclosure.

### DETAILED DESCRIPTION

The exemplary embodiments of the present disclosure are described below with reference to the accompanying drawings, which include various details of the embodiments of the present disclosure for the sake of better understanding and should be constructed as being only exemplary. Therefore, those ordinarily skilled in the art should realize that various changes and modifications can be made to the embodiments described herein without departing from the scope of the present disclosure. Similarly, for the sake of clarity and conciseness, description for known functions and structures is omitted in the following description.

In the present disclosure, unless otherwise stated, terms such as “first” and “second” used for describing various elements are not intended to limit a position relation, a sequence relation or a significance relation of these elements. These terms are only used for distinguishing one component from another component. In some examples, a first element and a second element may refer to the same instance of the elements, which, under certain circumstances, may also refer to different instances on the basis of the context.

Terms used in the description of the various examples in the present disclosure only aim to describe specific examples rather than intend to make a limitation. Unless otherwise indicated clearly in the context, the quantity of the elements may be one or more if the quantity of the elements is not particularly limited. Besides, a term “and/or” used in the present disclosure covers any one or all possible combinations of listed items.

The embodiments of the present disclosure will be described in detail below with reference to the accompanying drawings.

So far, various types of computers in application are based on classical physics as the theoretical basis for information processing, and are called traditional computers or classical computers. Classical information systems use physically easiest-to-implement binary data bits to store data or programs. Each of binary data bits is represented by 0 or 1, called a digit or bit, as a smallest information unit. The classical computer itself has inevitable weaknesses: first, the most basic limit of energy consumption in a computing process. Minimum energy required for a logic element or a memory cell should be several times more than kT to avoid malfunction due to thermal expansion; second, information entropy and heat energy consumption; and third, when a wiring density of computer chips is very large, according to Heisenberg’s uncertainty principle, if an uncertainty of an electron position is very small, an uncertainty of a momentum will be very large. Electrons are no longer bound, and there will be quantum interference effects that can even destroy performance of the chips.

A quantum computer is a kind of physical device that follows properties and laws of quantum mechanics to perform high-speed mathematical and logical operations, as well as to store and to process quantum information. When a certain device processes and computes quantum information and runs quantum algorithms, it is a quantum computer. Quantum computers follow the unique laws of quantum dynamics (especially quantum interference) to realize a new mode of information processing. For parallel processing of computing problems, quantum computers have absolute advantages in speed compared to classical computers. The transformation implemented by the quantum computer for each of superposition components is equivalent to a kind of classical calculation. All these classical calculations are completed at the same time, and they are superimposed according to a certain probability amplitude to give an output result of the quantum computer. This kind of calculation is called quantum parallel computing. Quantum parallel processing greatly improves the efficiency of quantum computers, allowing them to perform calculations that classical computers cannot finish within a reasonable time period, such as factoring a large natural number. Quantum coherence is fundamentally exploited in all quantum ultrafast algorithms. Therefore, quantum parallel computing that replaces a classical state with a quantum state can achieve an incomparable computing speed and information processing function compared to the classical computer, and at the same time save a lot of computing resources.

With the rapid development of quantum computer technology, due to its powerful computing power and higher operating speed, an application range of quantum computers is becoming wider and wider. For example, chemical simulation refers to a process of mapping a Hamiltonian of a real chemical system to a physically operable Hamiltonian, and then modulating parameters and evolution times to find eigenstates that can reflect the real chemical system. When simulating an N-electron chemical system on the classical computer, it involves the solution of a 2N-dimensional Schrödinger equation, and a calculation amount will increase exponentially with the increase of the number of electrons in the system. Therefore, the role of classical computers in chemical simulation problems is very limited. To break through this bottleneck, we must rely on the high computing power of quantum computers. Variational Quantum Eigensolver (VQE) is an efficient quantum algorithm for chemical simulations on quantum hardware. It is one of the most promising applications of quantum computers in the near future, opening up many new fields of chemical research. However, at the current stage, measurement noise rate of quantum computers obviously limits the ability of VQE, so the problem of quantum measurement noises must be solved first.

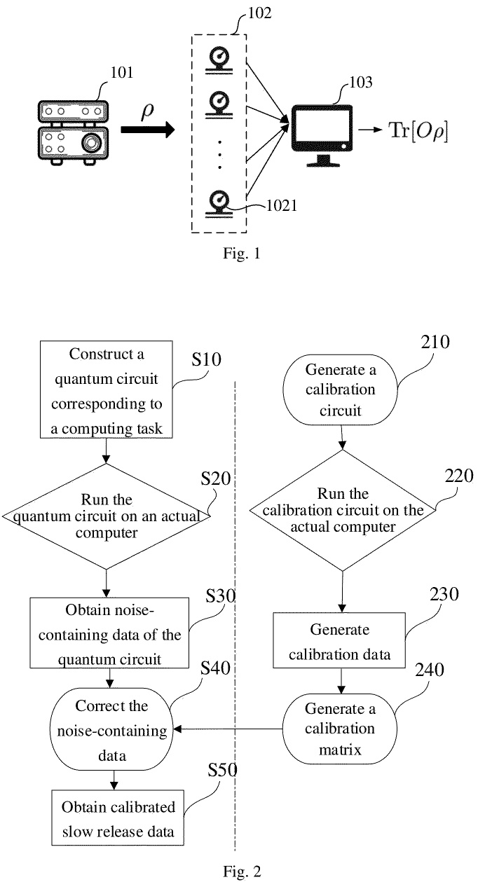

A core of the Variational Quantum Eigensolver (VQE) is to estimate an expected value Tr[0ρ], where ρ is an n-qubit quantum state generated by the quantum computer, and an n-qubit observable quantity 0 is the Hamiltonian of the real chemical system to map the physically operable Hamiltonian. The above process is a common form of extracting classical information through quantum computing, which is a core step in reading the classical information from quantum information. In general, it may be assumed that 0 is a diagonal matrix under one computing base, so theoretically the expected value Tr[0ρ] may be calculated through a formula (1):

$$T r \left[O ρ\right] = {\sum }_{i = 0}^{{2}^{n} - 1} O \left(i\right) ρ \left(i\right)$$

where 0(i) represents the ith row and ith column of elements of 0 (assuming that a matrix element index starts labeling from 0). The above quantum computing process is illustrated in FIG. 1. A process of generating the n-qubit quantum state ρ by the quantum computer 101 and measuring the quantum state ρ by one of a plurality of measurement device 102 to obtain a measurement result is executed M times, performing statistics on a frequency Mᵢ of an output result i. It is estimated that ρ(i) ≈ Mᵢ/M, and then Tr[0ρ] may be estimated through a classical computer 103. For example, the measurement device 102 may realize measurement of the n-qubit quantum state ρ through n (a positive integer) single-qubit measurement devices 1021 to obtain the measurement result. The law of large numbers ensures that when M is large enough, the above estimation process is correct.

However, during physical implementation, due to limitations of various factors such as instruments, methods, conditions, etc., the measurement device cannot work accurately, so measurement noises are generated, resulting in deviations between an actually estimated value Mᵢ/M and ρ(i). As a result, an error occurs to Tr[0ρ] calculated through the formula (1). A main problem is that, because of the measurement error, the frequency Mᵢ of the output result i after statistics is inaccurate. There are at least two main sources of noises in quantum measurement: first, a thermal fluctuation effect of a resonator itself and the noise generated in the measurement process will affect the distinguishability of different states; and second, qubits decay from an excited state to a ground state, resulting in an incorrect reading result. Therefore, how to reduce an effect of the measurement noise so as to obtain an unbiased estimate of Tr[0ρ] has become an urgent problem to be solved.

Generally, the measurement device may be calibrated first, and then the output result of the measurement device is corrected. A work flow is illustrated in FIG. 2. In this basic process of processing the measurement noise, an experimenter first prepares a plurality of calibration circuits (step 210), and then runs these calibration circuits in an actual measurement device (step 220) to detect basic information of the measurement device. Specifically, a corresponding calibration circuit may be constructed in a system shown in FIG. 1 through quantum computer 101 to obtain a corresponding standard basis quantum state. Calibration data is generated after the standard basis quantum state is measured by the measurement device 102 repeatedly (step 230).

A calibration matrix A may be constructed by using the generated calibration data (step 240). The matrix depicts noise information of a noise-containing measurement device. When a certain specific quantum computing task needs to be executed subsequently, a quantum circuit corresponding to the computing task may be constructed first (step S10), the quantum circuit corresponding to the task is run in an actual device (step S20), and noise-containing output data {Mᵢ}ᵢ of the quantum circuit is obtained (step S30). Then, the noise-containing data may be processed using the obtained calibration matrix A (step S40):

$$\text{q =} \left(\begin{matrix}{M}_{0} / M \\ {M}_{1} / M \\ ⋮ \\ {M}_{{2}^{n} - 1} / M\end{matrix}\right) , \text{p} \text{=} {A}^{- 1} \text{q}$$

where A^{–1} represents an inverse of the calibration matrix A. A probability distribution ρ after calibration is approximate to {ρ(i)}ᵢ, then the expected value Tr[0ρ] is calculated (step S50), thus improving precision of expected value calculation.

It can be seen from the basic process of processing the measurement noise shown in FIG. 2 that, a process of constructing the calibration matric A through the calibration data is essential, and matric A directly influences the probability distribution p after calibration, thus determining the precision of the expected value Tr[0ρ].

A current process of generating the calibration matrix A through the calibration data may be divided into two types, according to assumption of a calibration matrix structure: a tensor product model and a structureless model. In the tensor product model, the experimenter assumes that in the computing task as shown in FIG. 1, n qubit measurement devices do not influence each other, so it is merely needs to separately calculate calibration matrixes {Aₖ}ₖ of these qubit measurement devices from the calibration data, k = 1, ··· , n. Here, Aₖ is a 2 × 2 column random matrix, and a system calibration matrix with 2ⁿ × 2ⁿ may be obtained by solving a tensor product (mathematically represented by ⊗) on the n matrixes:

$$A = {⊗}_{k = 1}^{\text{n}} {A}_{k}$$

It can be seen that in the tensor product model, a calibration process may be simplified to a great extent by performing tensor assumption on the calibration matrix A. However, in a physical experiment, abundant experimental data show that, due to coupling of the qubits and the resonator, mutual effects between the qubits and an environment are enhanced. Thus, decoherence and dephase of the qubits become more severe, causing crosstalk of a qubit measurement result. However, because the tensor product model assumes that the n qubit measurement devices do not influence each other, the calibration matrix cannot be precisely depicted.

In order to solve the problem of crosstalk among the qubits, the structureless model does not make any structural assumption on the calibration matrix A, but directly deduces properties of the quantum measurement devices from the calibration data. A specific operation flow includes: standard basis quantum states |y > are prepared through the calibration circuits, where y ∈ {0,1}ⁿ. |y > is used as input, the noise-containing measurement device runs repeatedly for Nₛₕₒₜₛ times, and an output result after statistics is a frequency N_{x|y} of a binary character string x, where x ∈ {0,1}ⁿ. It can be seen from the definition:

$${N}_{s h o t s} = {\sum }_{x = 0}^{{2}^{n} - 1} {N}_{x \left|y\right)}$$

The yth column of elements of the calibration matrix A are calculated using a data set {N_{x|y}}_{x,y}. A_{xy} is set to represent an element at the xth row and the yth column in the 2ⁿ × 2ⁿ matrix A, and a value thereof is:

$${A}_{x y} = \frac{{N}_{x \vert y}}{{N}_{s h o t s}}$$

The yth column of the calibration matrix A may be obtained by calculating through exhaustion of all x ∈ {0,1}ⁿ. All columns of elements of A may be calculated through exhaustion of all y ∈ {0,1}ⁿ. The formula (4) ensures that the yth column of the calibration matrix A of the above construction satisfies a column random property. It should be strengthened that the formula (5) is an optimal solution given by a maximum likelihood estimate. Obviously, the larger the total repeated times Nₛₕₒₜₛ are, the more precise a noise matrix A is depicted, but the more calibration circuits need to prepare, and the larger a calculating overhead is.

In the present disclosure, the process corresponding to the above structureless model may be recorded as C, input of the process C is a qubit list (i.e. a group of qubits), and output thereof is the calibration matrix A corresponding to these qubits.

It can be seen that the structureless model well solves existing problem of the tensor product model; but it requires exhaustion of all standard basis quantum states |y > as the input y ∈ {0,1}ⁿ, each of the quantum states needs to be prepared Nₛₕₒₜₛ times, and statistics is performed on a statistics result obtained through output to demarcate the system calibration matrix A. In this way, the total number of calibration circuits the structureless model needs to prepare is:

$${2}^{n} \times {N}_{s h o t s}$$

The total number of calibration circuits the structureless model needs to prepare increases exponentially with the increase of the number n of the qubits, and an overhead of calculation resources will be excessively large. Correspondingly, the tensor product model merely needs to prepare two standard basis quantum states

$$\left|0...0\right〉 , \left|1...\right〉$$

as input, each of the quantum states needs to be prepared Nₛₕₒₜₛ times, and statistics is performed on a statistics result obtained through output to demarcate n qubit calibration matrixes {Aₖ}ₖ. In this way, the total number of calibration circuits the tensor product model needs to prepare is:

$$2 \times {N}_{s h o t s}$$

Compared with the structureless model, the tensor product model significantly saves computing resources.

Comparing the tensor product model with the structureless model, a trade-off relationship can be clearly seen when the quantum measurement device is calibrated: in order to depict quantum measurement crosstalk with high precision, more calibration circuits need to be prepared, and more computing resources need be consumed. The tensor product model and the structureless model represent two extremes of this trade-off relationship: the tensor product model does not consider measurement crosstalk at all and prepares the least number of calibration circuits; and the structureless model considers all possible measurement crosstalk and prepares the largest number of calibration circuits.

In that way, how to dynamically determine a precision of depicting measurement calibration between the two extremes according to existing computing resources has become an urgent problem to be solved.

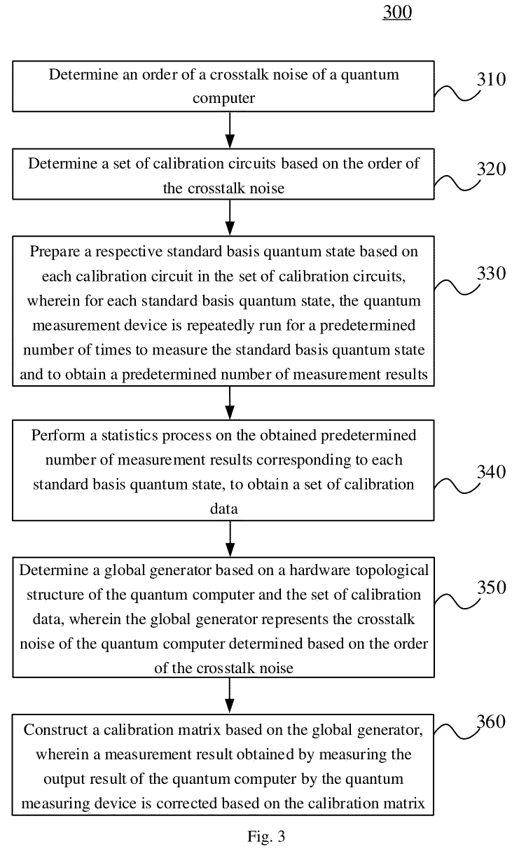

Therefore, a quantum measurement device calibration method is provided according to an embodiment of the present disclosure. As shown in FIG. 3, the quantum measurement device calibration method 300 includes: determine an order of a crosstalk noise of a quantum computer (step 310); determine a set of calibration circuits based on the order of the crosstalk noise (step 320); prepare a respective standard basis quantum state based on each calibration circuit in the set of calibration circuits, wherein for each standard basis quantum state, the quantum measurement device is repeatedly run for a predetermined number of times to measure the standard basis quantum state and to obtain a predetermined number of measurement results (step 330); perform a statistics process on the obtained predetermined number of measurement results corresponding to each standard basis quantum state, to obtain a set of calibration data (step 340); determine a global generator based on a hardware topological structure of the quantum computer and the set of calibration data, wherein the global generator represents the crosstalk noise of the quantum computer determined based on the order of the crosstalk noise (step 350); and construct a calibration matrix based on the global generator, wherein a measurement result obtained by measuring the output result of the quantum computer by the quantum measuring device is corrected based on the calibration matrix (step 360).

According to the embodiment of the present disclosure, the crosstalk noise order can be customized, and the calibration matrix of the customized crosstalk noise order can be constructed and depicted in a hardware adaptive way, thus realizing an ability of depicting the crosstalk noise in a finer way. In addition, various functions are provided, such as, balancing “measurement calibration precision” and “consumption of calibration resources” and selecting appropriate parameters according to features of hardware are provided. As a result, computing resources are greatly saved.

In the embodiment of the present disclosure, the crosstalk noise order of the quantum computer is first determined. Specifically, for given k qubits, an input ground state is prepared, and measurement is performed, if an obtained output state is exactly opposite to the input state (i.e. the k qubits are completely converted), a kth order crosstalk noise exists among the k qubits. Intuitively speaking, the kth order crosstalk noise means that the k qubits are fully associated. Here, a worker may designate a crosstalk noise order to be considered (for example, based on device performance). For example, a maximum crosstalk noise order K may be designated to be considered, and at the moment, all kth order (k = 1,2, ···, K) crosstalk noises need to be considered. Or, crosstalk noises of a certain order or certain orders (namely one or a plurality of kth orders) may be designated to be considered, which is not limited here.

In some embodiments, assuming that it is needed to depict the kth order crosstalk noise of the k qubits in the qubit set S = {Q₀, ···, Qₖ₋₁}, the calibration data set may be obtained based on a structureless model process C, and further, the 2^{k} × 2^{k} calibration matrix A^{S} is obtained through calculation based on the calibration data set. 2^{k} reverse diagonal elements of the matrix depict a probability that the output state of the k qubits is exactly opposite to the input state, i.e. a probability that the k qubits are completely converted.

In some embodiments, a matrix logarithm is solved on the calibration matrix A^{S}, the obtained 2^{k} reverse diagonal elements of the matrix define the weight coefficient of a kth-order crosstalk noise

$${\left\{{λ}_{i}\right\}}_{i = 0}^{{2}^{k} - 1}$$

of a set S. The weight coefficient completely depicts the kth order crosstalk noise of the k qubits represented by S:

$${\left\{{λ}_{i}\right\}}_{i = 0}^{{2}^{k} - 1} = a n t i d i a g \left(l o g \left({A}^{s}\right)\right)$$

where antidiag(A) represents all selected reverse diagonal elements of the matrix A (a selection sequence is from lower left to upper right), and log (A) represents matrix logarithm calculation.

It can be seen from the definition of weight coefficient that, the kth-order crosstalk noise is depicted by 2^{k} elements, and each of weight coefficients λᵢ depicts a specific conversion error of the k qubits. In some embodiments, the error may be depicted using a 2ⁿ × 2ⁿ generator gᵢ:

$${g}_{i} = \left|{2}^{n} - 1 ⊕ i\right〉 \left〈i\right| - \left|i\right〉 \left〈i\right|$$

where ⊕ represents a binary xor operation, 2ⁿ - 1⊕i represents performing bitwise inversion after binary expansion of the positive integer i, and n is the qubit quantity of the quantum computer. Intuitively speaking, gᵢ depicts an event: “the standard basis quantum state |i) is input, and either a bit string i or a completely converted bit string 2ⁿ - 1⊕i is output. It should be emphasized that, the generator gᵢ defined by the formula (9) defaults to tensor to an entire n-qubit space, thus the 2ⁿ × 2ⁿ matrix is realized. 2^{k} generators (i.e. local generators) may be obtained through exhaustion of i ∈ {0, ···, 2^{k} - 1}. In conclusion, the kth order crosstalk noise among the k qubits may be completely depicted through the following two-tuples:

$${\left\{{λ}_{i} , {g}_{i}\right\}}_{i = 0}^{{2}^{k} - 1}$$

For example, when k = 2, a 2^{nd} order crosstalk noise of 2 qubits S = {Q₀, Q₁} needs to be depicted. A 4 × 4 calibration matrix As may be calculated from the calibration data set based on the structureless model:

$${A}^{S} = \left(\begin{matrix} & & & {A}_{03} \\ & & {A}_{12} & \\ & {A}_{21} & & \\ {A}_{30} & & & \end{matrix}\right)$$

4 reverse diagonal elements are listed in the formula (11), and other elements are non-associated. Based on the above description and analysis, Table 1 may be obtained.

Table 1

| Element | Generator | Physical meaning |
|---|---|---|
| A₃₀ | \|11〉〈00\| - \|00〉〈00\| | Depicting a probability that the input state is “00” the output state is “11” |
| A₂₁ | \|10〉〈01\| - \|01〉〈01\| | Depicting a probability that the input state is “01” the output state is “10” |
| A₁₂ | \|01〉〈10\| - \|10〉〈10\| | Depicting a probability that the input state is “10” the output state is “01” |
| A₀₃ | \|00〉〈11\| - \|11〉〈11\| | Depicting a probability that the input state is “11” the output state is “00” |

where the 4 reverse diagonal elements representing the calibration matrix A^{S} completely depicts the probability that the quantum state input and output of the two qubits are completely converted, i.e. depicts the 2^{nd} order crosstalk noise.

The k qubits with a kth order crosstalk above is a subset of a part of qubits in the n qubit measurement devices of a system.

After describing how to depict the crosstalk noise and its intensity among the k qubits, it is needed to judge which k qubits in hardware requires analysis of its kth order crosstalk noise. It can be understood that, a simplest judging method is assuming the kth order crosstalk noises exist between any k qubits in the hardware, where for the hardware containing the n qubits, the total quantity of the kth order crosstalk noises may be represented by a combinatorial number

$$\left(\begin{matrix}n \\ k\end{matrix}\right)$$

.

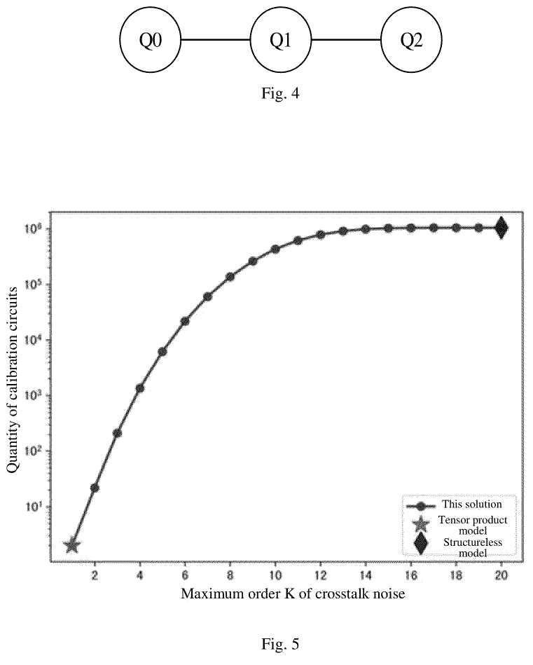

However, the above judging method does not consider a topological structure of the hardware. Exemplarily, when two qubits are non-associated and are far away from each other, experimental data shows that a crosstalk between the two qubits is weak. Therefore, the method of the embodiment of the present disclosure combines the topological structure of the hardware of the quantum computer itself to select which k qubits in the quantum measurement device require consideration of the kth order crosstalk noises. In general, a hardware topological structure containing n qubits may be depicts using a simple undirected graph Ω = (V, E), where V is a node set (corresponding to the qubits in the hardware), and E is an edge set (depicting association among the qubits in the hardware). FIG. 4 illustrates a diagram of a hardware topological structure containing three qubits. A corresponding simple undirected graph is: Ω = (V, E), V = {Q0, Q1, Q2), E = {(Q0, Q1), (Q1, Q2)}.

It is assumed that the kth order crosstalk noise exits among k certain qubits, if and only if the node set corresponding to the k qubits is a kth order connected subgraph in the simple undirected graph. Intuitively speaking, if nodes corresponding to the k qubits are connected to each other on the undirected graph, it can be considered that the kth order crosstalk noise will exist between them. As shown in FIG. 4, for the hardware depicted by the undirected graph, the kth order crosstalk noise may be classified as follows: (1) considering a 1^{st} order crosstalk noise, namely qubits (Q0), (Q1), (Q2), and (Q3). If only the 1^{st} order crosstalk noise is considered, a noise model degenerates into a tensor product model, i.e. we don’t care about multi-bit crosstalk noise at all. (2) Considering a 2^{nd} order crosstalk noise, that is, qubit pairs (Q0, Q1) and (Q1, Q2). Intuitively, these two groups of qubits are adjacent in hardware structure, and control signals are likely to interfere with each other. On the other hand, the qubit pair (Q0, Q2) is not adjacent, so there is no 2^{nd} order crosstalk. (3) Considering a 3^{rd} order crosstalk noise, that is, a qubit pair (Q0, Q1, Q2).

After determining which k qubits in the current device hardware may have the kth order crosstalk noise, in order to calculate the noise intensity, the calibration circuit (i.e., the first step in the structureless model process C) needs to be prepared to obtain the set of calibration data {N_{x|y}}_{x,y}.

In the embodiment where consideration of the maximum crosstalk noise order K is designated, assuming that a maximum Kth order crosstalk noise of the quantum measurement device needs to be depicted (apparently, K <= n), the calibration circuit needs to be prepared so as to ensure that the weight coefficients of all kth order (k = 1,2, ··· ,K) crosstalk may be obtained based on the set of calibration data. The quantity of the calibration circuits needed when k = 1 has been given in the tensor product model: 2 × Nₛₕₒₜₛ. With the increase of the crosstalk noise order, more calibration circuits are needed to collect sufficient data to calculate all the weight coefficients. Therefore, the calibration circuit set shown in Table 2 may be constructed. Calibration data collected by these calibration circuits may be used to calculate the weight coefficient of the maximum Kth order crosstalk noise.

Table 2

| | | |
|---|---|---|
| Standard basis quantum state | Quantity | Description |
| \|0 ··· 0〉 | 1 | All 0 inputs |
| \|1 ··· 1〉 | 1 | All 1 inputs |
| \|10 ··· 0〉 and its permutation and combination | n | One 1 input |
| \|110 ··· 0〉 and its | $\left(\begin{matrix}n \\ 2\end{matrix}\right)$ | Two 1 inputs |
| permutation and combination | | |
| ··· | ··· | ··· |
| \|1··· 10 ··· 0〉 and its permutation and combination, where the quantity of 1 is K - 1 | $\left(\begin{matrix}n \\ K - 1\end{matrix}\right)$ | (K - 1) 1 inputs |

According to Table 2, it can be known through calculation that, the quantity of different needed calibration circuits may be represented as:

$$1 + {\sum }_{k = 0}^{K - 1} \left({}_{k}^{n}\right)$$

Each of the calibration circuits needs to be run Nₛₕₒₜₛ times on the noise-containing measurement device, so the total quantity of the calibration circuits may be represented as:

$$\left(1 + {\sum }_{k = 0}^{K - 1} \left({}_{k}^{n}\right)\right) \times {N}_{s h o t s}$$

FIG. 5 illustrates a graph showing the relationship between the quantity of calibration circuits and a maximum crosstalk noise order in the tensor product model, the structureless model and the above embodiment. It can be seen that, with the increase of the maximum crosstalk noise order to be depicted, the quantity of the calibration circuits is increased exponentially. When K is relatively small, increase of the needed calibration circuits grows smoothly, but the crosstalk noise of the measurement device may be depicted already. Experimenters may select an appropriate maximum crosstalk noise order K in combination with this drawing and a crosstalk noise intensity of an actual device.

In some examples, the predetermined number of times Nₛₕₒₜₛ may be set in advance by the experimenters according to properties of the device, which is not limited here.

As described above, the kth order crosstalk noise between k-qubit subsets in the n qubit measurement devices may be completely depicted by the two-tuples:

$${\left\{{λ}_{i} , {g}_{i}\right\}}_{i = 0}^{{2}^{k} - 1} .$$

The 2^{k} local generators gᵢ and their corresponding weight coefficients λᵢ, the global generator corresponding to the n qubit measurement devices may be determined through iteration.

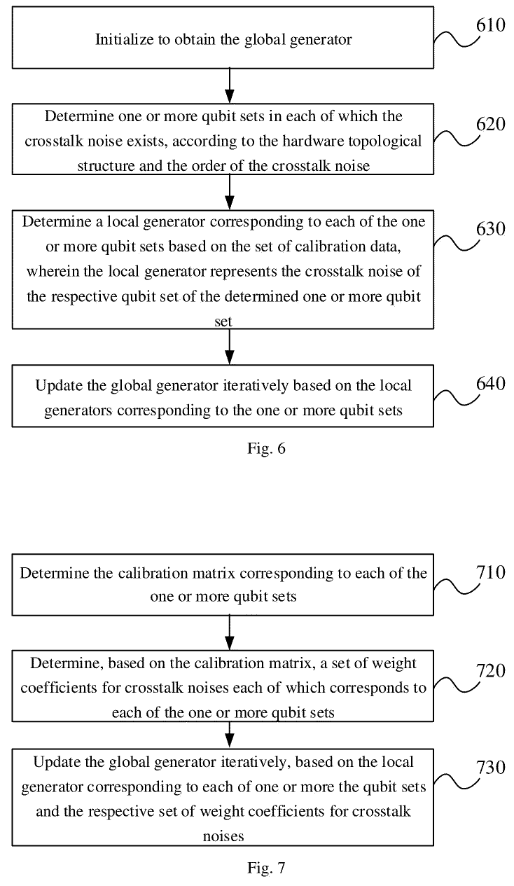

According to some embodiments, as shown in FIG. 6, determining the global generator based on the hardware topological structure of the quantum computer and the set of calibration data may include: initialize to obtain the global generator (step 610); determine one or more qubit sets in each of which the crosstalk noise exists, according to the hardware topological structure and the order of the crosstalk noise (step 620); determine a local generator corresponding to each of the one or more qubit sets based on the set of calibration data, wherein the local generator represents the crosstalk noise of the respective qubit set of the determined one or more qubit set (step 630); and update the global generator iteratively based on the local generators corresponding to the one or more qubit sets (step 640).

According to some embodiments, as shown in FIG. 7, updating the global generator iteratively based on all the local generators may include: determine the calibration matrix corresponding to each of the one or more qubit sets (step 710); determine, based on the calibration matrix, a set of weight coefficients for crosstalk noises each of which corresponds to each of the one or more qubit sets (step 720); and update the global generator iteratively, based on the local generator corresponding to each of one or more the qubit sets and the respective set of weight coefficients for crosstalk noises (step 730).

According to some embodiments, the global generator G is updated iteratively based on the following formula:

$$\text{G} = \text{G} + {\sum }_{i = 0}^{{2}^{k} - 1} {λ}_{i} {g}_{i}$$

where k is the quantity of the qubits of each of the qubit sets, k is a positive integer, and λᵢ and gᵢ are respectively the weight coefficient of ith crosstalk noise and local generator corresponding to the qubit set.

According to one embodiment of the present disclosure, the maximum crosstalk noise order K is considered, i.e. crosstalk noises with an order of K or below K are considered. Therefore, the calibration matrix A may be determined through the following steps.

In step 1, the maximum crosstalk noise order K is set, and a calibration circuit set is constructed according to Table 1. The calibration circuits need to be prepared to ensure that the weight coefficients of all kth order crosstalk (k = 1,2, ···, K) may be obtained based on the calibration data set.

In step 2, for each of the calibration circuits (a standard basis quantum state prepared by it is made to be |y〉) in the calibration circuit set, the calibration circuit runs repeatedly for Nₛₕₒₜₛ times, and an output result after statistics is the number of times N_{x|y} of a binary character string x, where x, y ∈ {0, 1}ⁿ. After completion of step 2, the set of calibration data {N_{x|y}}_{x,y} is obtained.

In step 3, the global generator G is initialized to a 2ⁿ × 2ⁿ all-zero matrix.

In step 4, for k = 1, 2, ···, K, kth order crosstalk noise depicting data is generated and is added to G according to the following sub-steps:

First sub-step in step 4: all kth order connected subgraphs {S} are generated according to the hardware topological structure, and the subgraphs are all labeled as “unprocessed”.

Second sub-step in step 4: inquiry is made about an unprocessed subgraph S, the quantity of nodes of which is k, corresponding to k qubits. 2^{k} local generators

$${\left\{{g}_{i}\right\}}_{i = 0}^{{2}^{k} - 1}$$

of these k qubits are calculated using the data set {N_{x|y}}_{x,y} and the formula (9), and the weight coefficients

$${\left\{{λ}_{i}\right\}}_{i = 0}^{{2}^{k} - 1}$$

corresponding to the k qubits are calculated through the formula (8).

Third sub-step in step 4: the global generator G is updated:

$$G = G + {\sum }_{i = 0}^{{2}^{k} - 1} {λ}_{i} {g}_{i}$$

Fourth sub-step in step 4: S is labeled as “processed”, and then the operation skips to the second sub-step in step 4. If all subgraphs are labeled as “processed”, the operation skips to step 5.

In step 5: the calibration matrix A is calculated through the following formula based on the global generator G:

$$A = {e}^{G}$$

Through the above steps, the calibration matrix A depicting at most Kth order crosstalk is obtained according to the embodiment of the present disclosure, and is used for subsequent noise-containing data correction.

In another embodiment of the present disclosure, only crosstalk noises with an order of k are considered, so the calibration matrix A may be determined through the following steps.

In step 1, the crosstalk noise order k is set, and the set of calibration circuit is constructed according to Table 1.

In step 2, for each of the calibration circuits (a standard basis quantum state prepared by it is made to be |y〉) in the set of calibration circuit, the calibration circuit runs repeatedly for Nₛₕₒₜₛ times, and an output result after statistics is the number of times N_{x|y} of a binary character string x, where x, y ∈ {0,1}ⁿ. After completion of step 2, the set of calibration data {N_{x|y}}_{x,y} is obtained.

In step 3, the global generator G is initialized to a 2ⁿ × 2ⁿ all-zero matrix.

In step 4, kth order crosstalk noise depicting data is generated according to the following sub-steps:

First sub-step in step 4: kth order connected subgraphs {S} are generated according to the hardware topological structure, and the subgraphs are all labeled as “unprocessed”.

Second sub-step in step 4: inquiry is made about an unprocessed subgraph S, the quantity of nodes of which is k, corresponding to k qubits. 2^{k} local generators

$${\left\{{g}_{i}\right\}}_{i = 0}^{{2}^{k} - 1}$$

of these k qubits are calculated using the data set {N_{x|y}}_{x,y} and the formula (9), and the weight coefficients

$${\left\{{λ}_{i}\right\}}_{i = 0}^{{2}^{k} - 1}$$

corresponding to the k qubits are calculated through the formula (8).

Third sub-step in step 4: the global generator G is updated:

$$G = G + {\sum }_{i = 0}^{{2}^{k} - 1} {λ}_{i} {g}_{i}$$

Fourth sub-step in step 4: S is labeled as “processed”, and then the operation skips to the second sub-step in step 4. If all subgraphs are labeled as “processed”, the operation skips to step 5.

In step 5: the calibration matrix A is calculated through the following formula based on the global generator G:

$$A = {e}^{G}$$

Through the above steps, the calibration matrix A depicting designated kth order crosstalk noise is obtained according to the embodiment of the present disclosure, and is used for subsequent noise-containing data correction.

According to an embodiment of the present disclosure, as shown in FIG. 8, a quantum measurement device calibration apparatus 800 is further provided and includes: a first determining unit 810, configured to determine a crosstalk noise order of a quantum computer; a second determining unit 820, configured to determine a calibration circuit set based on the crosstalk noise order; a measurement unit 830, configured to prepare standard basis quantum states respectively based on each of the calibration circuits in the calibration circuit set, so as to repeatedly run a measurement device for a predetermined number of times for each of the standard basis quantum states to measure the standard basis quantum states; a statistics unit 840, configured to perform statistics on an obtained measurement result of the predetermined number of times corresponding to each of the standard basis quantum states, so as to obtain a calibration data set; a third determining unit 850, configured to determine a global generator based on a hardware topological structure of the quantum computer and the calibration data set, wherein the global generator represents a crosstalk noise of the quantum computer determined based on the crosstalk noise order; and a calibration unit 860, configured to construct a calibration matrix based on the global generator, so as to correct the measurement result of the quantum computer based on the calibration matrix.

Here, operations of the above units 810 to 860 of the quantum measurement device calibration apparatus 800 are similar to the operations of steps 310 to 360 described above, which will not be repeated here.

According to embodiments of the present disclosure, an electronic device, a readable storage medium, and a computer program product are further provided.

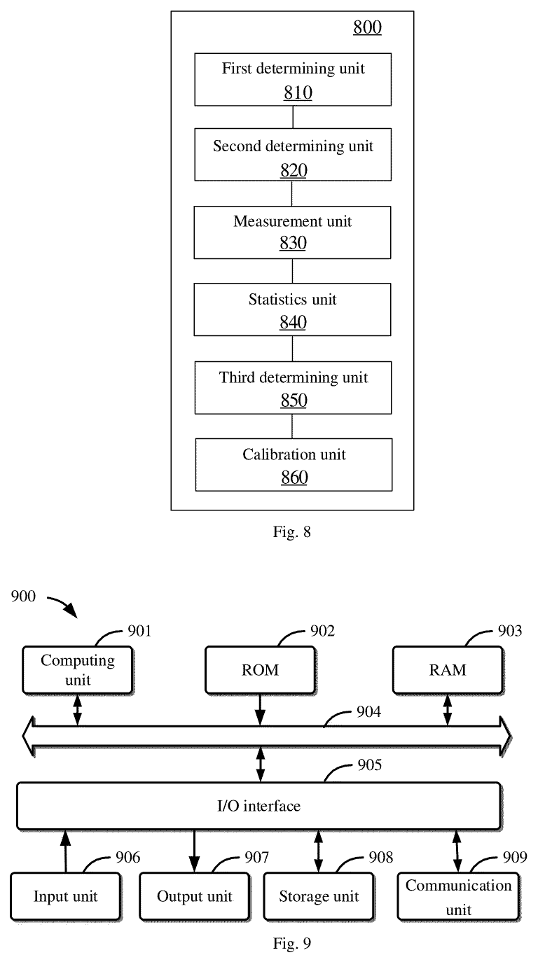

Referring to FIG. 9, a structural block diagram of an electronic device 900 that may serve as a server or a client of the present disclosure is now described, which is an instance of hardware devices that may be applied to various aspects of the present disclosure. The electronic device is intended to represent various forms of digital electronic computer devices, such as laptop computers, desktop computers, workstations, personal digital assistants, servers, blade servers, mainframe computers, and other suitable computers. The electronic device may also represent various forms of mobile apparatuses, such as personal digital processors, cellular phones, smart phones, wearable devices, and other similar computing apparatuses. The components shown herein, their connections and relationships, and their functions serve as examples only, and are not intended to limit implementations of the disclosure described and/or claimed herein.

As shown in FIG. 9, the electronic device 900 includes a computing unit 901 which may execute various appropriate actions and processing according to a computer program stored in a read-only memory (ROM) 902 or a computer program loaded to a random access memory (RAM) 903 from a storage unit 908. In the RAM 903, various programs and data needed for operations of the electronic device 900 may be further stored. The computing unit 901, the ROM 902 and the RAM 903 are mutually connected through a bus 904. An input/output (I/O) interface 905 is also connected to the bus 904.

A plurality of components in the electronic device 900 are connected to the I/O interface 905, including: an input unit 906, an output unit 907, the storage unit 908 and a communication unit 909. The input unit 906 may be any type of device capable of inputting information to the electronic device 900. The input unit 906 may receive input number or character information and generate key signal input related to a user setting and/or function control of the electronic device and may include but not limited to a mouse, a keyboard, a touch screen, a trackpad, a trackball, a joystick, a microphone and/or a remote control. The output unit 907 may be any type of device capable of displaying information and may include but not limited to a display, a speaker, a video/audio output terminal, a vibrator and/or a printer. The storage unit 908 may include but not limited to a magnetic disk and a compact disc. The communication unit 909 allows the electronic device 900 to exchange information/data with other devices through a computer network, such as the Internet, and/or various telecommunication networks, and may include but not limited to a modem, a network card, an infrared communication device, a wireless communication transceiver and/or a chipset, for example, a Bluetooth TM device, a 802.11 device, a WiFi device, a WiMax device, a cellular communication device and/or similar items.

The computing unit 901 may be various general-purpose and/or special-purpose processing components with processing and computing capacity. Some examples of the computing unit 901 include but not limited to a central processing unit (CPU), a graphics processing unit (GPU), various special-purpose artificial intelligence (AI) computing chips, various computing units for running a machine learning model algorithm, a digital signal processor (DSP), and any appropriate processor, controller, microcontroller and the like. The computing unit 901 executes each method and processing described above, for example, the method 300. For example, in some embodiments, the method 300 may be realized as a computer software program, which is tangibly contained in a machine readable medium, for example, the storage unit 908. In some embodiments, a part of or all of the computer program may be loaded and/or installed onto the electronic device 900 via the ROM 902 and/or the communication unit 909. When the computer program is loaded to the RAM 903 and executed by the computing unit 901, one or more steps of the method 300 described above can be executed. Alternatively, in other embodiments, the computing unit 901 may be configured to execute the method 300 in any other appropriate mode (for example, by means of firmware).

Various implementations of the systems and technologies described above in this paper may be implemented in a digital electronic circuit system, an integrated circuit system, a field programmable gate array (FPGA), an application specific integrated circuit (ASIC), an application specific standard part (ASSP), a system on chip (SOC), a complex programmable logic device (CPLD), computer hardware, firmware, software and/or their combinations. These various implementations may include: being implemented in one or more computer programs, wherein the one or more computer programs may be executed and/or interpreted on a programmable system including at least one programmable processor, and the programmable processor may be a special-purpose or general-purpose programmable processor, and may receive data and instructions from a storage system, at least one input apparatus, and at least one output apparatus, and transmit the data and the instructions to the storage system, the at least one input apparatus, and the at least one output apparatus.

Program codes for implementing the methods of the present disclosure may be written in any combination of one or more programming languages. These program codes may be provided to processors or controllers of a general-purpose computer, a special-purpose computer or other programmable data processing apparatuses, so that when executed by the processors or controllers, the program codes enable the functions/operations specified in the flow diagrams and/or block diagrams to be implemented. The program codes may be executed completely on a machine, partially on the machine, partially on the machine and partially on a remote machine as a separate software package, or completely on the remote machine or server.

In the context of the present disclosure, a machine readable medium may be a tangible medium that may contain or store a program for use by or in connection with an instruction execution system, apparatus or device. The machine readable medium may be a machine readable signal medium or a machine readable storage medium. The machine readable medium may include but not limited to an electronic, magnetic, optical, electromagnetic, infrared, or semiconductor system, apparatus or device, or any suitable combination of the above contents. More specific examples of the machine readable storage medium will include electrical connections based on one or more lines, a portable computer disk, a hard disk, a random access memory (RAM), a read only memory (ROM), an erasable programmable read only memory (EPROM or flash memory), an optical fiber, a portable compact disk read only memory (CD-ROM), an optical storage device, a magnetic storage device, or any suitable combination of the above contents.

In order to provide interactions with users, the systems and techniques described herein may be implemented on a computer, and the computer has: a display apparatus for displaying information to the users (e.g., a CRT (cathode ray tube) or LCD (liquid crystal display) monitor); and a keyboard and a pointing device (e.g., a mouse or trackball), through which the users may provide input to the computer. Other types of apparatuses may further be used to provide interactions with users; for example, feedback provided to the users may be any form of sensory feedback (e.g., visual feedback, auditory feedback, or tactile feedback); an input from the users may be received in any form (including acoustic input, voice input or tactile input).

The systems and techniques described herein may be implemented in a computing system including background components (e.g., as a data server), or a computing system including middleware components (e.g., an application server) or a computing system including front-end components (e.g., a user computer with a graphical user interface or a web browser through which a user may interact with the implementations of the systems and technologies described herein), or a computing system including any combination of such background components, middleware components, or front-end components. The components of the system may be interconnected by digital data communication (e.g., a communication network) in any form or medium. Examples of the communication network include: a local area network (LAN), a wide area network (WAN) and the Internet.

A computer system may include a client and a server. The client and the server are generally away from each other and usually interact through a communication network. A relation between the client and the server is generated by a computer program running on a computer program with a mutual client-server relation on a corresponding computer. The server may be a cloud server, or a server of a distributed system, or a server combined with a blockchain.

It should be understood that steps can be reranked, added or deleted by using various forms of flows shown above. For example, all the steps recorded in the present disclosure can be executed in parallel, or in sequence or in different orders, which is not limited herein as long as a desired result of the technical solutions disclosed by the present disclosure can be realized.

Though the embodiments or the examples of the present disclosure are already described with reference to the accompanying drawings, it should be understood that the above method, system and device are only exemplary embodiments or examples, and the scope of present disclosure is not limited by these embodiments or examples but limited only by the scope of the authorized claims and their equivalents. Various elements in the embodiments or the examples may be omitted or replaced by their equivalent elements. Besides, all the steps may be executed in sequence different from a sequence described in the present disclosure. Furthermore, various elements in the embodiments or the examples may be combined in various modes. What counts is that with technology evolution, many elements described here can be replaced by equivalent elements appearing after the present disclosure.

1. A method for calibrating a quantum measurement device, comprising:
determining an order of a crosstalk noise of a quantum computer;
determining a set of calibration circuits based on the order of the crosstalk noise;
preparing a respective standard basis quantum state based on each calibration circuit in the set of calibration circuits, wherein for each standard basis quantum state, the quantum measurement device is repeatedly run for a predetermined number of times to measure the standard basis quantum state and to obtain a predetermined number of measurement results;
performing a statistic process on the obtained predetermined number of measurement results corresponding to each standard basis quantum state to obtain a set of calibration data;
determining a global generator based on a hardware topological structure of the quantum computer and the set of calibration data, wherein the global generator represents the crosstalk noise of the quantum computer determined based on the order of the crosstalk noise; and
constructing a calibration matrix based on the global generator, wherein a measurement result obtained by measuring the output result of the quantum computer by the quantum measuring device is corrected based on the calibration matrix.

2. The method according to claim 1, wherein determining the global generator based on the hardware topological structure of the quantum computer and the set of calibration data comprises:
initializing to obtain the global generator;
determining one or more qubit sets in each of which the crosstalk noise exists, according to the hardware topological structure and the order of the crosstalk noise;
determining a local generator corresponding to each of the one or more qubit sets based on the set of calibration data, wherein the local generator represents the crosstalk noise of the respective qubit set of the determined one or more qubit set; and
updating the global generator iteratively based on the local generators corresponding to the one or more qubit sets.

3. The method according to claim 2, wherein the local generator corresponding to each of the one or more qubit sets is determined based on a following formula:
$${g}_{i} = \left|{2}^{n} - 1 ⊕ i\right〉 \left〈i\right| - \left|i\right〉 \left〈i\right|$$
where i = 0,1,..., 2^{k} - 1, k is a quantity of qubits in the respective qubit set and k is a positive integer, and n is a quantity of qubits of the quantum computer.

4. The method according to claim 2, wherein updating the global generator iteratively based on the local generators corresponding to the one or more qubit sets comprises:
determining the calibration matrix corresponding to each of the one or more qubit sets;
determining, based on the calibration matrix, a set of weight coefficients for crosstalk noises each of which corresponds to each of the one or more qubit sets; and
updating the global generator iteratively, based on the local generator corresponding to each of one or more the qubit sets and the respective set of weight coefficients for crosstalk noises.

5. The method according to claim 4, wherein the global generator G is updated iteratively based on the following formula:
$$\text{G} = \text{G} + {\sum }_{i = 0}^{{2}^{k} - 1} {\text{λ}}_{i} {g}_{i}$$
where k is a quantity of qubits in each of the qubit sets and k is a positive integer, and λᵢ and gᵢ are respectively the ith weight coefficient of crosstalk noise and local generator corresponding to each of the qubit sets.

6. The method according to claim 1, wherein the calibration matrix A is constructed based on the following formula:
$$A = {e}^{G}$$
where G is the global generator.

7. The method according to claim 4, wherein the weight coefficient of a kth-order crosstalk noise is determined based on the following formula:
$${\left\{{λ}_{i}\right\}}_{i = 0}^{{2}^{k} - 1} = a n t i d i a g \left(l o g \left({A}^{S}\right)\right)$$
where antidiag() represents acquiring all reverse diagonal elements.

8. An electronic device, comprising:
a memory storing one or more programs configured to be executed by one or more processors, the one or more programs including instructions for causing the electronic device to perform operations comprising:
determining an order of a crosstalk noise of a quantum computer;
determining a set of calibration circuits based on the order of the crosstalk noise;
preparing a respective standard basis quantum state based on each calibration circuit in the set of calibration circuits, wherein for each standard basis quantum state, the quantum measurement device is repeatedly run for a predetermined number of times to measure the standard basis quantum state and to obtain a predetermined number of measurement results;
performing a statistic process on the obtained predetermined number of measurement results corresponding to each standard basis quantum state to obtain a set of calibration data;
determining a global generator based on a hardware topological structure of the quantum computer and the set of calibration data, wherein the global generator represents the crosstalk noise of the quantum computer determined based on the order of the crosstalk noise; and
constructing a calibration matrix based on the global generator, wherein a measurement result obtained by measuring the output result of the quantum computer by the quantum measuring device is corrected based on the calibration matrix.

9. The electronic device according to claim 8, wherein determining the global generator based on the hardware topological structure of the quantum computer and the set of calibration data comprises:
initializing to obtain the global generator;
determining one or more qubit sets in each of which the crosstalk noise exists, according to the hardware topological structure and the order of the crosstalk noise;
determining a local generator corresponding to each of the one or more qubit sets based on the set of calibration data, wherein the local generator represents the crosstalk noise of the respective qubit set of the determined one or more qubit set; and
updating the global generator iteratively based on the local generators corresponding to the one or more qubit sets.

10. The electronic device according to claim 9, wherein the local generator corresponding to each of the one or more qubit sets is determined based on a following formula:
$${g}_{i} = \left|{2}^{n} - 1 ⊕ i\right〉 \left〈i\right| - \left|i\right〉 \left〈i\right|$$
where i = 0,1,..., 2^{k} -1, k is a quantity of qubits in the respective qubit set and k is a positive integer, and n is a quantity of qubits of the quantum computer.

11. The electronic device according to claim 9, wherein updating the global generator iteratively based on the local generators corresponding to the one or more qubit sets comprises:
determining the calibration matrix corresponding to each of the one or more qubit sets;
determining, based on the calibration matrix, a set of weight coefficients for crosstalk noises each of which corresponds to each of the one or more qubit sets; and
updating the global generator iteratively, based on the local generator corresponding to each of one or more the qubit sets and the respective set of weight coefficients for crosstalk noises.

12. The electronic device according to claim 11, wherein the global generator G is updated iteratively based on the following formula:
$$\text{G} \text{=} \text{G} + {\sum }_{i = 0}^{{2}^{k} - 1} {λ}_{i} {g}_{i}$$
where k is a quantity of qubits in each of the qubit sets and k is a positive integer, and λᵢ and gᵢ are respectively the ith weight coefficient of crosstalk noise and local generator corresponding to each of the qubit sets.

13. The electronic device according to claim 8, wherein the calibration matrix A is constructed based on the following formula:
$$A = {e}^{G}$$
where G is the global generator.

14. The electronic device according to claim 11, wherein the weight coefficient of a kth-order crosstalk noise is determined based on the following formula:
$${\left\{{λ}_{i}\right\}}_{i = 0}^{{2}^{k} - 1} = a n t i d i a g \left(l o g \left({A}^{S}\right)\right)$$
where antidiag() represents acquiring all reverse diagonal elements.

15. A non-transitory computer-readable storage medium that stores one or more programs comprising instructions that, when executed by one or more processors of an electronic device, cause the electronic device to perform operations comprising:
determining an order of a crosstalk noise of a quantum computer;
determining a set of calibration circuits based on the order of the crosstalk noise;
preparing a respective standard basis quantum state based on each calibration circuit in the set of calibration circuits, wherein for each standard basis quantum state, the quantum measurement device is repeatedly run for a predetermined number of times to measure the standard basis quantum state and to obtain a predetermined number of measurement results;
performing a statistic process on the obtained predetermined number of measurement results corresponding to each standard basis quantum state to obtain a set of calibration data;
determining a global generator based on a hardware topological structure of the quantum computer and the set of calibration data, wherein the global generator represents the crosstalk noise of the quantum computer determined based on the order of the crosstalk noise; and
constructing a calibration matrix based on the global generator, wherein a measurement result obtained by measuring the output result of the quantum computer by the quantum measuring device is corrected based on the calibration matrix.

16. The non-transitory computer-readable storage medium according to claim 15, wherein determining the global generator based on the hardware topological structure of the quantum computer and the set of calibration data comprises:
initializing to obtain the global generator;
determining one or more qubit sets in each of which the crosstalk noise exists, according to the hardware topological structure and the order of the crosstalk noise;
determining a local generator corresponding to each of the one or more qubit sets based on the set of calibration data, wherein the local generator represents the crosstalk noise of the respective qubit set of the determined one or more qubit set; and
updating the global generator iteratively based on the local generators corresponding to the one or more qubit sets.

17. The non-transitory computer-readable storage medium according to claim 16, wherein the local generator corresponding to each of the one or more qubit sets is determined based on a following formula:
$${g}_{i} = \left|{2}^{n} - 1 ⊕ \left(i\right〉 \left〈i\right)\right| - \left|\left(i\right〉 \left〈i\right)\right|$$
where i = 0,1, ..., 2^{k} - 1, k is a quantity of qubits in the respective qubit set and k is a positive integer, and n is a quantity of qubits of the quantum computer.

18. The non-transitory computer-readable storage medium according to claim 16, wherein updating the global generator iteratively based on the local generators corresponding to the one or more qubit sets comprises:
determining the calibration matrix corresponding to each of the one or more qubit sets;
determining, based on the calibration matrix, a set of weight coefficients for crosstalk noises each of which corresponds to each of the one or more qubit sets; and
updating the global generator iteratively, based on the local generator corresponding to each of one or more the qubit sets and the respective set of weight coefficients for crosstalk noises.

19. The non-transitory computer-readable storage medium according to claim 18, wherein the global generator G is updated iteratively based on the following formula:
$$\text{G} \text{=} \text{G} + {\sum }_{i = 0}^{{2}^{k} - 1} {λ}_{i} {g}_{i}$$
where k is a quantity of qubits in each of the qubit sets and k is a positive integer, and λᵢ and gᵢ are respectively the ith weight coefficient of crosstalk noise and local generator corresponding to each of the qubit sets.

20. The non-transitory computer-readable storage medium according to claim 15, wherein the calibration matrix A is constructed based on the following formula:
$$A = {e}^{G}$$
where G is the global generator.
